(19) United States
(12) Patent Application Publication
(10) Pub. No.: US 2015/0022971 A1
(43) Pub. Date: Jan. 22, 2015

(54) Computer Case Provided with a Side Plate Having Power Supply Lines

(71) Applicants: Hyoung-Min Jung, Ulsan (KR); GRAEA INC., Ulsan (KR)

(72) Inventor: Hyoung-Min Jung, Ulsan (KR)

(21) Appl. No.: 14/367,622

(22) PCT Filed: Nov. 29, 2013
(86) PCT No.: PCT/KR2013/011006

§ 371 Date: Jun. 20, 2014

(30) Foreign Application Priority Data
Dec. 6, 2012 (KR) 20-2012-0011479
Jun. 20, 2013 (KR) 10-2013-0071263

(51) Int. Cl. G06F 1/18

(52) U.S. Cl. CPC G06F 1/189; G06F 1/181
USPC 361/679.58

(57) ABSTRACT

The present invention relates to a computer case provided with aside plate having power supply lines, in which a plurality of electronic components including a power supplier and wirings are disposed, and a main board is mounted on one side of the side plate, and the computer case including: power supply lines installed on the side plate; input ports which are mounted on one surface of the side plate and are connected to one ends of the power supply lines so that power supply ports of the power supplier are inserted to supply the power to the power supply lines; and output ports which are mounted on one surface of the side plate and is connected to the other ends of the power supply lines so that electronic component ports of the electronic components are inserted to supply the power to the electronic components.

### CROSS-REFERENCE TO RELATED APPLICATION

This application is a Section 371 National Stage Application of International Application No. PCT/KR2013/011006, filed on Nov. 29, 2013, the entire contents of which are incorporated herein by reference.

### BACKGROUND OF THE INVENTION

1. Technical Field

The present invention relates to a computer case. More particularly, the present invention relates to a computer case provided with a side plate having power supply lines for cleanly arranging wirings located in the internal space of the computer case through a side plate with the power supply line.

2. Background Art

In general, a computer is constituted by electronic components that include a computer case, a metallic frame that is installed in the internal space of the computer case, a power supply that is fixedly attached to the frame, a main board, a hard disk driver, a CD-ROM driver, a cooling fan, a power/reset switch, a USB terminal, a power lamp and the like.

A number of electronic components are basically connected to the power supply or the main board through a plurality of the power supply wirings to be supplied with a driving voltage, respectively, and a data input/output device such as a hard disk driver and a CD-ROM driver is connected to the main board via a data cable, thereby performing input and output of the data.

Various electronic components are mounted on the inside of the computer case, various wirings including all power supply wires are disposed along with the electronic components, but these wirings have caused inconveniences and problems as follows.

In the case of attempting to replace a graphic card, the electronic components mounted on the main board like a LAN card, or various data devices, or in the case of cleaning the interior of the computer, there have been many inconveniences in which various wirings complicatedly disclosed inside the computer block a moving line for replacement and cleaning of the components to make the work complicated and there is a need to check the status of the wirings by opening and closing the computer case on both sides.

Furthermore, there has been a problem in that peripheral wirings connected to various electronic components are frequently touched during replacement or cleaning work for the above-described reason and in this case, the wiring terminals may fallout of the electronic components or make the connected state instable, thereby causing malfunction of the computer.

Furthermore, there has been a problem in that due to an arrangement structure in which bundles of various wirings occupy many spaces inside the computer and cover the main board, the flow of air is blocked, the cooling efficiency of the interior of the computer is lowered, and thus, the main board vulnerable to heat is adversely affected.

In order to solve the aforementioned problems, Korean Patent No. 10-1018670 discloses “computer case with side plates for wiring arrangement”.

Referring to FIG. 1, a computer case in which a number of electronic components and wirings are disposed inside the computer case provided with a side plate 10 for wiring arrangement, and a side plate 10 on which the main board is mounted is included on one side thereof is configured so that the side plate 10 is formed with a plurality of wiring entering and exiting holes 12 passing through a thickness portion 10, the respective wirings are drawn out to the outer surface of the side plate 10 through the wiring entering and exiting holes, and then the wirings are drawn into the inner side surfaces of the side plates through another wiring entering and exiting hole 12 and are connected to the electronic components.

However, in such a case, there is a problem in that, in order to allow the wirings to pass through the wiring entering and exiting holes 12, a user needs to note the arrangement of the electronic components to be installed inside the computer case.

In addition, there is a problem in that an extension cable is required for a position of the wiring entering and exiting holes 12 that do not match the length of the wiring of the power supply.

At the same time, there is a problem in that, in order to replace or repair the power supply, there is a need to remove all the wirings connected to the electronic components, and the removed wirings need to be taken out via the wiring entering and exiting holes 12, thereby significantly lowering the work efficiency.

### DISCLOSURE

### Technical Problem

The present invention has been made to solve the above-described problems, and an object thereof is to provide power supply lines in a side plate so as to be able to supply the power by being connected to the electronic components within the computer casing, thereby perfectly arranging the power supply wirings.

Furthermore, another object of the present invention is to facilitate the repair and the replacement of the electronic components or the power supply provided inside the computer case, thereby enhancing the work efficiency.

Furthermore, still another object of the present invention is to allow installation of the electronic components manufactured by the respective manufacturers without using a separate extension line when the electronic components do not match the length of the power supply lines in a case where the electronic components having non-uniform sizes, depending on the manufacturers of the electronic components as in the related art, are connected to the power supply, thereby improving the commercial characteristics.

Furthermore, still another object of the present invention is in that, even if the side plate is prepared with a transparent material, since the wirings inside the computer case are cleanly arranged, it is possible to check the status of the components inside the computer in real time without opening the computer case, thereby enhancing the aesthetics.

### Technical Solution

In order to achieve the above and other objects of the present invention, according to an exemplary embodiment of the present invention, there is provided a computer case provided with a side plate having power supply lines, in which a plurality of electronic components including a power supplier and wirings are disposed, and a main board is mounted on one side of the side plate, wherein the computer case is configured to include: power supply lines installed on the side plate, input ports which are mounted on one surface of the side plate and are connected to one ends of the power supply lines so that power supply ports of the power supplier are inserted to supply the power to the power supply lines, and output ports which are mounted on one surface of the side plate and are connected to the other ends of the power supply lines so that electronic component ports of the electronic components are inserted to supply the power to the electronic components.

Furthermore, there is provided a computer case provided with a side plate having a power supply lines, in which a plurality of electronic components including a power supplier and wirings are disposed, and a main board is mounted on one side of the side plate, wherein the computer case is configured to include: power supply lines installed on the side plate, input ports which are mounted on one surface of the side plate and are connected to one ends of the power supply lines so that power supply ports of the power supplier are inserted to supply the power to the power supply lines, output ports which are mounted on one surface of the side plate and are connected to the other ends of the power supply lines so that electronic component ports of the electronic components are inserted to supply the power to the electronic components, and at least one or more cable fasteners attachably and detachably coupled to the side plate so that the power supply lines are arranged.

The input ports input ports are mounted in a region where the power supplier is installed so that the insertion of the power supply ports connected to the power supplier is facilitated.

The output ports are mounted in the respective regions where a number of electronic components are installed so as to facilitate the insertion of the electronic component ports.

A cover configured to shield the wirings is provided at a predetermined position inside the computer case.

The cable fasteners are constituted by a body having a plurality of through-holes formed therein so as to be spaced apart by a predetermined distance, and coupling protrusions formed below both sides of the body.

### Advantageous Effect

According to an exemplary embodiment of the present invention, there is an effect in which by providing the input and output ports for allowing the input and the output of the power supply and the power supply lines connected thereto on the side plate of the computer case, it is possible to cleanly arrange the wirings that are complicatedly disposed inside the computer case, thereby preventing the malfunction due to the wirings and improving the cooling efficiency.

Furthermore, there is an effect that facilitates the repair and the replacement of the electronic components or the power supplier provided inside the computer case, thereby enhancing the work efficiency.

Furthermore, there is an effect in which, in a case where attempting to connect the electronic components having the non-uniform sizes, depending on the manufacturers of the electronic components as in the related art, to the power supplier when the electronic components do not match the length of the power supply lines, the electronic components manufactured by the respective manufacturers can be installed without using a separate extension lines, thereby improving the commercial characteristic.

Furthermore, since the wirings inside the computer case are cleanly arranged even if the side plate is prepared with a transparent material, it is possible to check the status of the components inside the computer in real time without opening the computer case, thereby enhancing the aesthetics.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a perspective view illustrating the structure of the side plate of the conventional computer case.

FIG. 2 is a perspective view schematically illustrating a configuration of the computer case provided with the side plate having the power supply lines according to an exemplary embodiment of the present invention.

FIG. 3 is a perspective view of the computer case provided with the side plate having the power supply lines according to an embodiment of the present invention.

FIG. 4 is a perspective view of the side plate illustrated in FIG. 3.

FIG. 5 is a cross-sectional view illustrating the structure of the power supply ports and the input ports illustrated in FIG. 3.

FIG. 6 is a perspective view of a computer case provided with the side plate having the power supply lines according to another embodiment of the present invention.

FIG. 7 is a perspective view of a computer case provided with the side plate having the power supply lines according to another embodiment of the present invention.

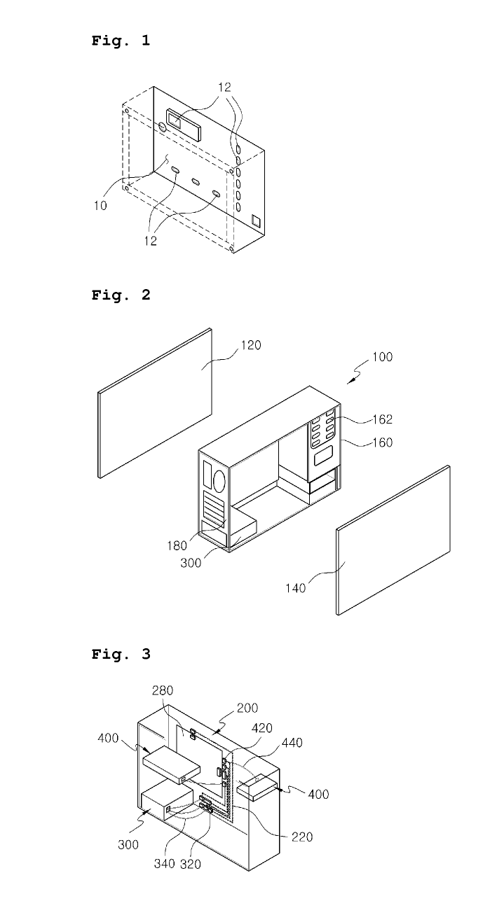

### PREFERRED EMBODIMENTS OF THE INVENTION

Hereinafter, preferred embodiments of the present invention will be described in more detail with reference to the accompanying drawings. In this process, the thicknesses of the lines, the sizes of the components illustrated in the drawings may be exaggerated for clarity and convenience of the following description.

Furthermore, terms to be described below are terms defined in consideration of the functions of the present invention and may be changed depending on the intention and the convention of users and operators. Therefore, the definition of these terms needs to be made on the basis of the contents throughout the specification.

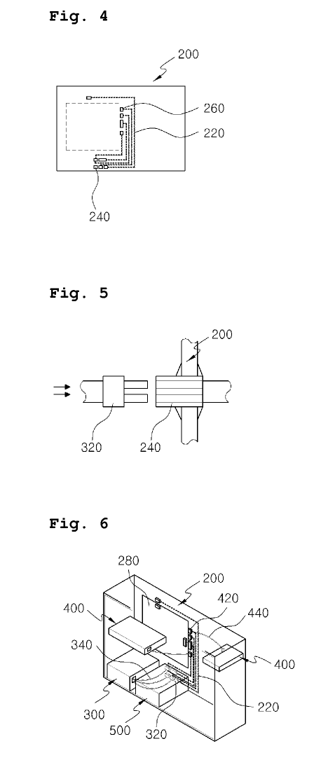

FIG. 2 is a perspective view schematically illustrating a configuration of the computer case provided with the side plate having the power supply lines according to an exemplary embodiment of the present invention. FIG. 3 is a perspective view of the computer case provided with the side plate having the power supply lines according to an embodiment of the present invention. FIG. 4 is a perspective view of the side plate illustrated in FIG. 3. FIG. 5 is a cross-sectional view illustrating the structure of the power supply ports and the input ports illustrated in FIG. 3. FIG. 6 is a perspective view of a computer case provided with the side plate having the power supply lines according to another embodiment of the present invention.

Here, a computer case 100 according to an exemplary embodiment of the present invention is configured to include a frame, side covers 120 and 140 that are attachably and detachably coupled to both sides of the frame to shield the interior of the computer case 100 from the exterior, and a side plate 200 in which a plurality of electronic components 400 including a power including power supplier 300 and wirings 340 and 440 are disposed therein and on one side of which a main board 280 is mounted.

Furthermore, a front surface of the computer case 100 is provided with a front surface plate 160 in which a hard disk rack 162 to store a hard disk driver and a CD-ROM rack (not illustrated) to store a CD-ROM driver are installed, and a rear surface thereof is provided with a rear surface plate 180 to which a cooling fan (not illustrated) and the power supplier 300 are coupled.

Referring to FIGS. 2 to 5, the computer case 100 provided with the side plate having the power supply lines according to an exemplary embodiment of the present invention includes power supply lines 220 installed on the side plate 200, an input ports 240 connected to the power supply lines 220 at one end thereof, and output ports 260 connected to the other end of the power supply lines 220.

Furthermore, the side plate 200 is installed on the inner surface of the computer case 100, and a main board 280 is installed on the one side.

The input ports 240 are mounted on one surface of the side plate 200 and are connected to one end of the power supply lines 220 so that the power supply ports 320 of the power supplier 300 are inserted to supply the power to the power supply lines 220.

Such an input ports 240 are preferably provided in the side plate 200 at a distance as close as possible to the power supplier 300 so that the power supply ports 320 of the power supplier 300 are easily inserted and the wirings 340 are prevented from being densely complicated after being inserted.

The output ports 260 are mounted on one surface of the side plate 200 and are connected to the other end of the power supply lines 220 so that the electronic component ports 420 of the electronic components 400 are inserted to supply the power to the electronic components 400.

Such output ports 260 are preferably provided in the sideplate 200 at a distance as close as possible to the respective electronic components 400 so that the electronic component ports 420 are easily inserted at the position where a plurality of electronic components 400 are installed, and the wirings 440 are prevented from being densely complicated after being inserted.

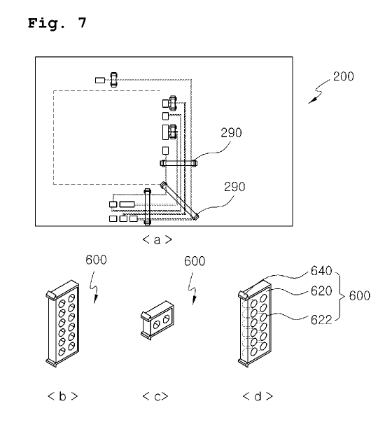

Meanwhile, FIG. 7 is a perspective view of a computer case provided with the side plate having the power supply lines according to another embodiment of the present invention.

The computer case 100 provided with the side plate having the power supply lines according to another embodiment of the present invention illustrated in FIG. 7 are the same as an embodiment of the present invention except that a cable fastener 600 is attachably and detachably coupled to the side plates 200.

Therefore, the repeated descriptions thereof will not be provided.

At least one or more cable fasteners 600 are provided so as to arrange the power supply lines 220 and are attachably and detachably coupled to the side plates 200.

Such a cable fastener 600 is configured to include a body 620 formed with a plurality of through-holes 622 to be spaced apart at a predetermined distance, and coupling protrusions 640 formed below both sides of the body 620 to be caught and coupled to the insertion grooves 290 formed on the side plate 200.

Here, the through-holes 622 are provided with a PVC-based soft material, which facilitates the insertion of the power supply lines 220 inserted into the through-holes 622, and firmly fixes the inserted power supply lines 220.

The through-holes 622 are provided by a multi-layer including a plurality of rows and columns to allow the respective power supply lines 220 inserted into the through-holes 622 to be efficiently distributed and inserted.

Furthermore, the through-holes 622 may also be formed inside of the body 620 so as to be sloped.

At the same time, at a predetermined position within the computer case 100 provided with the side plate having the power supply lines according to an embodiment and another embodiment of the present invention, a cover 500 may also be provided so as to be able to shield the wirings 340, and the cover 500 improves the aesthetics of the interior of the computer case 100 by covering the wirings 340 exposed on the side plate 200.

Therefore, the computer case with the side plate side having the power supply lines according to an exemplary embodiment of the present invention is able to cleanly arrange the wirings that are complicatedly disposed within the computer case, by installing the input and output ports allowing the input and the output of the power supply and the power supply lines connected thereto on the side plate of the computer case, and thus, there is an effect capable of preventing malfunction due to the wiring and improving the cooling efficiency.

Furthermore, there is an effect that facilitates the repair and the replacement of the electronic components or the power supplier provided inside the computer case, thereby enhancing the work efficiency.

Furthermore, there is an effect in which, in a case of attempting to connect the electronic components having the non-uniform sizes, depending on the manufacturers of the electronic components as in the related art, to the power supplier when the electronic components do not match the length of wirings of the power supplier, it is possible to install the electronic components manufactured by the respective manufacturers without using a separate extension line, thereby improving the commercial characteristics.

Furthermore, since the wirings within the computer case are cleanly arranged even if the side plate is prepared with a transparent material, it is possible to check the status of the components inside the computer in real time without opening the computer case, thereby enhancing the aesthetics.

The preferred embodiments of the present invention have been described with reference to the accompanying drawings, but it will be understood that a person having an ordinary skill in the art is able to variously modify and change the present invention within the scope that does not depart from the spirit of the present invention as set forth in the following claims

### INDUSTRIAL APPLICABILITY

The present invention relates to a computer case, and can be used as a computer case provided with the side plate having the power supply lines for cleanly arranging the wirings located in the internal space of the computer case through the side plate in which the power supply lines are installed.

1. A computer case provided with a side plate having power supply lines, in which a plurality of electronic components including a power supplier and wirings are disposed, and a main board is mounted on one side of the side plate, comprising:
power supply lines installed on the side plate;
input ports which are mounted on one surface of the side plate and are connected to one ends of the power supply lines so that power supply ports of the power supplier are inserted to supply the power to the power supply lines; and
output ports which are mounted on one surface of the side plate and are connected to the other ends of the power supply lines so that electronic component ports of the electronic components are inserted to supply the power to the electronic components.

2. A computer case provided with a side plate having a power supply lines, in which a plurality of electronic components including a power supplier and wirings are disposed, and a main board is mounted on one side of the side plate comprising:
power supply lines installed on the side plate;
input ports which are mounted on one surface of the side plate and are connected to one ends of the power supply lines so that power supply ports of the power supplier are inserted to supply the power to the power supply lines;
output ports which are mounted on one surface of the side plate and are connected to the other ends of the power supply lines so that electronic component ports of the electronic components are inserted to supply the power to the electronic components; and
at least one or more cable fasteners that are attachably and detachably coupled to the side plate so that the power supply lines are arranged.

3. The computer case provided with the side plate having the power supply lines of claim 1, wherein the input ports are mounted in a region where the power supplier is installed so that the insertion of the power supply ports connected to the power supplier is facilitated.

4. The computer case provided with the side plate having the power supply lines of claim 1, wherein the output ports are mounted in the respective regions where the plurality of electronic components are installed so as to facilitate the insertion of the electronic component ports.

5. The computer case provided with the side plate having the power supply lines of claim 1, wherein a cover configured to shield the wirings is provided at a predetermined position inside the computer case.

6. The computer case provided with the side plate having the power supply lines of claim 2, wherein the cable fasteners are constituted by a body having a plurality of through-holes formed therein so as to be spaced apart by a predetermined distance, and coupling protrusions formed below both sides of the body.

7. The computer case provided with the side plate having the power supply lines of claim 2, wherein the input ports are mounted in a region where the power supplier is installed so that the insertion of the power supply ports connected to the power supplier is facilitated.

8. The computer case provided with the side plate having the power supply lines of claim 2, wherein the output ports are mounted in the respective regions where the plurality of electronic components are installed so as to facilitate the insertion of the electronic component ports.

9. The computer case provided with the side plate having the power supply lines of claim 2, wherein a cover configured to shield the wirings is provided at a predetermined position inside the computer case.
